(19) United States
(12) Patent Application Publication
(10) Pub. No.: US 2025/0214175 A1
(43) Pub. Date: Jul. 3, 2025

(54) THREE-DIMENSIONAL LASER BEAM MACHINING APPARATUS, MACHINING PROGRAM GENERATION DEVICE, METHOD FOR THREE-DIMENSIONAL LASER BEAM MACHINING, AND RECORDING MEDIUM RECORDING PROGRAM

(71) Applicant: Sodick Co., Ltd., Kanagawa (JP)

(72) Inventors: Toshio KAJI, Kanagawa (JP); Tatsuro HAYAKAWA, Kanagawa (JP); Ichiro ARAIE, Kanagawa (JP)

(73) Assignee: Sodick Co., Ltd., Kanagawa (JP)

(21) Appl. No.: 18/964,636

(22) Filed: Dec. 1, 2024

(30) Foreign Application Priority Data
Dec. 27, 2023 (JP) 2023-220854

(51) Int. Cl. B23K 26/082; B23K 26/06; B23K 26/0622; B23K 26/38

(52) U.S. Cl. CPC B23K 26/082; B23K 26/0624; B23K 26/0648; B23K 26/38

(57) ABSTRACT

A three-dimensional laser beam machining apparatus includes a laser scanning head and a stage configured to be relatively movable with respect to each other, and a controller configured to control the laser scanning head and the stage based on a machining program. The machining program includes instructions regarding an irradiation sequence of the laser beam for a plurality of irradiation areas, each having the predetermined size. The plurality of irradiation areas are areas defined by dividing each of a plurality of layers, obtained by dividing a three-dimensional model of a target shape in a thickness direction, into a predetermined size in a surface direction using division lines. The division lines are offset from each other for each adjacent layer.

### CROSS-REFERENCE TO RELATED APPLICATION

This application claims the priority benefits of Japanese application No. 2023-220854, filed on Dec. 27, 2023. The entirety of the above-mentioned patent application is hereby incorporated by reference herein and made a part of this specification.

### BACKGROUND

### Technical Field

The disclosure relates to a three-dimensional laser beam machining apparatus, a method for three-dimensional laser beam machining, a machining program generation device, and a non-transitory recording medium recording program.

### Description of Related Art

A three-dimensional laser beam machining apparatus that executes removal machining using laser beam irradiation instead of using mechanical tools such as end mills is known. For example, Japanese Patent Application Laid-Open Publication No. 2012-016735A discloses a laser machining apparatus including a laser beam irradiation mechanism and a stage for holding a workpiece. This laser machining apparatus divides the machining target area of the workpiece into a plurality of areas and executes laser beam scanning for each divided area.

### SUMMARY

### Problems to be Solved

In the technique of dividing the machining target area into a plurality of areas and executing laser beam scanning for each of these plurality of areas, there may be a non-negligible difference in machining quality between the central area and the peripheral portion within each area. That is, owing to the discontinuity in scanning, a relative decrease in machining quality may be observed at the boundary portion between adjoining areas.

### Means for Solving the Problems

According to the disclosure, a three-dimensional laser beam machining apparatus is provided, including: a laser scanning head, configured to remove a part of a workpiece by scanning a surface of the workpiece with a laser beam using an irradiation area of a predetermined size as a unit; a stage, supporting the workpiece; and a controller, configured to control, based on a machining program, an irradiation of the laser beam from the laser scanning head to the workpiece, and a relative movement between the laser scanning head and the stage. The laser scanning head and the stage are configured to be relatively movable with respect to each other. The machining program includes instructions regarding an irradiation sequence of the laser beam for a plurality of irradiation areas, each having the predetermined size. The plurality of irradiation areas are areas defined by dividing each of a plurality of layers, obtained by dividing a three-dimensional model of a target shape in a thickness direction, into a predetermined size in a surface direction using division lines, and the division lines are offset from each other for each adjacent layer.

Further, according to the disclosure, a method for three-dimensional laser beam machining of a three-dimensional laser beam machining apparatus based on a machining program generated by a method for generating a machining program is provided. The three-dimensional laser beam machining apparatus includes a laser scanning head, configured to remove a part of a workpiece by scanning a surface of the workpiece with a laser beam using an irradiation area of a predetermined size as a unit; and a stage, supporting the workpiece. The laser scanning head and the stage are configured to be relatively movable with respect to each other. The method for generating the machining program includes: a slicing process of obtaining a plurality of layers by dividing a three-dimensional model of a target shape in a thickness direction; an irradiation area setting process, of dividing each of the plurality of layers into a predetermined size in a surface direction with division lines to generate a plurality of irradiation areas, wherein the division lines are offset from each other for each adjacent layer; an extraction process of extracting a set of irradiation areas that include at least a part of the target shape from the plurality of irradiation areas; a sorting process of rearranging an irradiation sequence of the irradiation areas included in the set based on predetermined conditions; and an output process of outputting a machining program as a machining instruction for the three-dimensional laser beam machining apparatus based on the irradiation sequence that is rearranged. The method for three-dimensional laser beam machining includes obtaining the target shape by scanning a surface of a workpiece with a laser beam in units of the irradiation area and removing a part of the workpiece in the irradiation sequence according to the machining program.

Moreover, according to the disclosure, a machining program generation device is provided, including an arithmetic circuit that executes the slicing process, the irradiation area setting process, the extraction process, the sorting process, and the output process.

In addition, according to the disclosure, a non-transitory recording medium is provided, recording a program that causes a computer to execute the slicing process, the irradiation area setting process, the extraction process, the sorting process, and the output process.

### Effects

According to any embodiment of the disclosure, it is possible to suppress the deterioration of machining quality that may occur in response to the enlargement of the workpiece. In particular, the machining program generated by the embodiment of the disclosure is applied for the three-dimensional laser beam machining apparatus to improve the control of the laser scanning head as well as relative movement between laser scanning head and the stage. This results in improvements in improved machining quality in the field of three-dimensional laser beam machining.

### BRIEF DESCRIPTION OF THE DRAWINGS

FIG. 1 is an exemplary perspective view showing the external appearance of the three-dimensional laser beam machining apparatus according to the embodiment.

FIG. 2 is a schematic perspective view of the three-dimensional laser beam machining apparatus with the exterior casing of the machining unit removed.

FIG. 3 is a schematic view of the optical system of the machining unit.

FIG. 4 shows another example of the scanner.

FIG. 5 is a block diagram showing an example of the control system in the three-dimensional laser beam machining apparatus.

FIG. 6 is a flowchart showing an example of the method for generating machining program according to this embodiment.

FIG. 7 shows the relationship between a slice at a certain height of a three-dimensional model of the target shape and the area that may be scanned at once by the laser scanning head.

FIG. 8 shows an example of dividing a machining layer into a plurality of irradiation areas.

FIG. 9 is a schematic diagram showing the division in the first layer superimposed on the division in the second layer.

FIG. 10 shows an example of a list after rearranging labels representing each irradiation area under predetermined conditions.

FIG. 11 shows an example of a numerical control program corresponding to the list shown in FIG. 10.

FIG. 12 shows an example where irradiation areas of a plurality of machining layers are positioned within a predetermined range centered on the beam waist.

### DESCRIPTION OF THE EMBODIMENTS

Hereinafter, the embodiment is described with reference to the drawings. The characteristic features shown in the embodiments described below may be combined with each other. Further, each characteristic feature constitutes an invention independently.

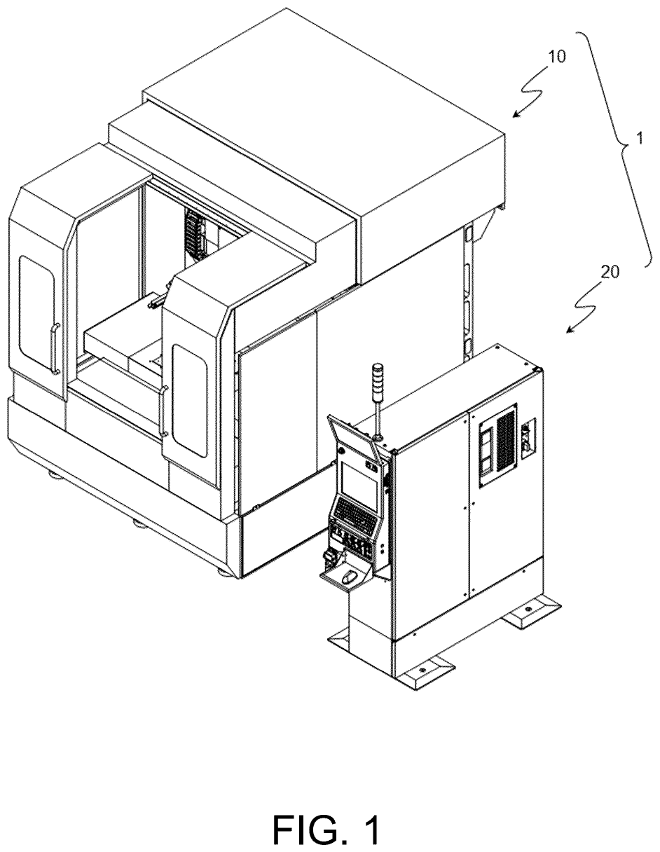

FIG. 1 shows an exemplary external appearance of a three-dimensional laser beam machining apparatus 1 according to an embodiment of the disclosure. The three-dimensional laser beam machining apparatus 1 shown in FIG. 1 is a three-dimensional removal machining system utilizing pulsed laser irradiation, and includes a machining unit 10 and a control unit 20. As described later, the machining unit 10 has a laser scanning head 12 and a stage 14. The control unit 20 controls the operation of the laser scanning head 12 and the stage 14 based on a machining program.

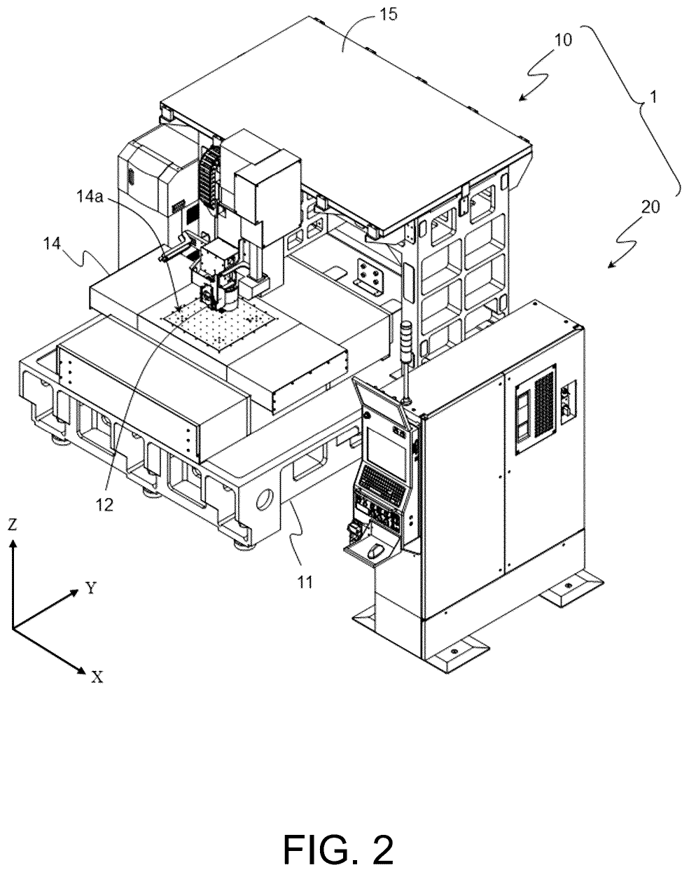

FIG. 2 shows the three-dimensional laser beam machining apparatus 1 with the exterior casing of the machining unit 10 removed. In FIG. 2, for the convenience of description, three arrows indicating mutually orthogonal X-axis, Y-axis, and Z-axis are depicted. Here, the X-axis and Y-axis are parallel to the horizontal direction, and the Z-axis is parallel to the vertical direction. The horizontal plane composed of the X-axis and Y-axis is referred to as the X-Y plane. In other figures, arrows indicating the X-axis, Y-axis, and Z-axis may also be illustrated.

The machining unit 10 includes a frame 11, the laser scanning head 12, the stage 14, and an optical surface plate 15. The frame 11 is a structure that supports the laser scanning head 12, the stage 14, and the optical surface plate 15. At least one of the laser scanning head 12 and the stage 14 is configured to be movable up and down in the Z-direction relative to the frame 11 based on instructions from the control unit 20, for example, by a combination of a stepping motor and a ball screw. In this embodiment, the laser scanning head 12 is supported by the frame 11 to be movable in the Z-direction relative to the frame 11. The drive mechanism that relatively moves the laser scanning head 12 and the stage 14 in the Z-direction may have any suitable actuator.

The stage 14 of the machining unit 10 is supported by the frame 11 to be movable within the X-Y plane relative to the laser scanning head 12 by means of a drive mechanism including a linear motor, etc. The drive mechanism that moves the stage 14 may have any suitable actuator, and instead of a linear motor, it may be composed of a combination of a stepping motor and a ball screw.

The stage 14 has an upper surface 14a on which a workpiece is placed for removal machining. The workpiece is, for example, a bulk metal material. The upper surface 14a of the stage 14 is parallel to the X-Y plane. During removal machining, the workpiece is fixed to the stage 14 by a fixture or the like on the upper surface 14a, and moves parallel within a plane perpendicular to the Z-direction according to the movement of the stage 14.

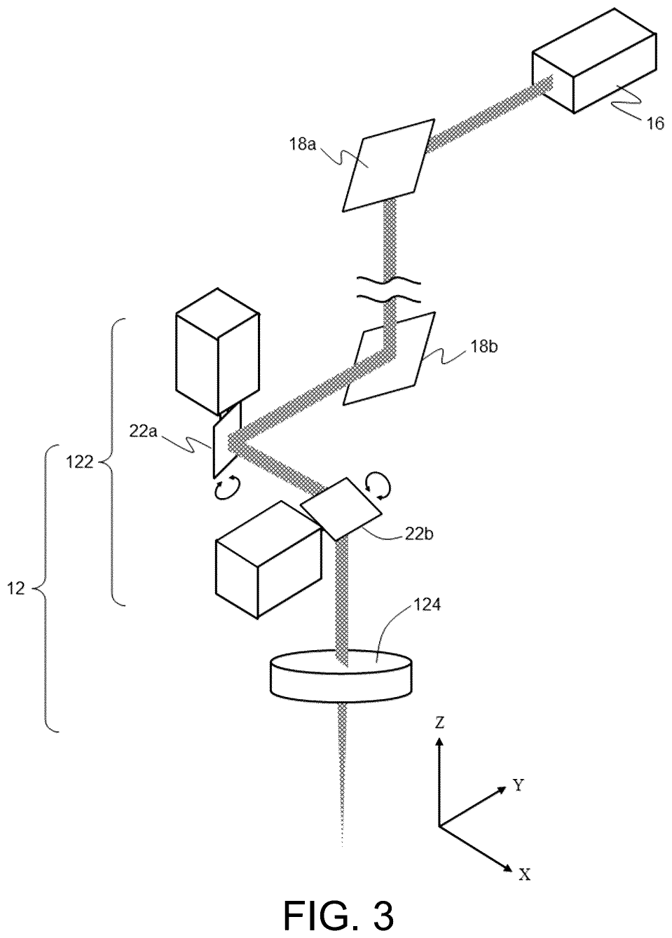

FIG. 3 schematically shows an outline of the optical system of the machining unit 10. The optical system of the machining unit 10 includes the laser scanning head 12 and a laser beam source 16 optically coupled to the laser scanning head 12. In the configuration exemplified in FIG. 3, the laser scanning head 12 includes a scanner 122 and an fθ lens 124.

The laser beam source 16 is configured within the machining unit 10, for example, by being fixed to the optical surface plate 15 supported on the upper portion of the frame 11. The laser beam emitted from the laser beam source 16 is guided to the scanner 122 of the laser scanning head 12 by being reflected by mirrors 18a, 18b, etc. Other optical elements such as a collimator, beam expander, etc. may be interposed between the laser beam source 16 and the scanner 122.

The laser beam source 16 may be applied without particular restriction to YAG lasers, fiber lasers, gas lasers, etc., as long as it is a pulsed laser beam source capable of achieving a fluence exceeding the grinding threshold of the material constituting the workpiece. The typical pulse width (FWHM: full width at half maximum) of the laser irradiated from the laser scanning head 12 toward the workpiece is on the order of 500 nanoseconds or less. The pulse width of the laser irradiated toward the workpiece may be in the range of 1 nanosecond to 500 nanoseconds, or in the range of 1 nanosecond to 100 nanoseconds. Alternatively, the pulse width may be on the order of several nanoseconds.

The laser beam source 16 may be a femtosecond laser oscillator. In other words, the three-dimensional laser beam machining apparatus 1 may be a three-dimensional removal machining system that includes the laser scanning head 12 which irradiates the workpiece with a femtosecond laser beam. By applying a femtosecond laser beam, it is possible to suppress the deterioration of the workpiece owing to heat generated during machining.

In the configuration exemplified in FIG. 3, the laser scanning head 12 includes a galvanometer scanner as the scanner 122. The galvanometer scanner includes two galvanometer mirrors, each connected to an actuator. In the example shown in FIG. 3, the scanner 122 includes a first galvanometer mirror 22a rotatable around a first axis and a second galvanometer mirror 22b rotatable around a second axis that is not parallel to the first axis. The light introduced from the laser beam source 16 to the laser scanning head 12 proceeds toward the fθ lens 124 after being sequentially reflected by the first galvanometer mirror 22a and the second galvanometer mirror 22b.

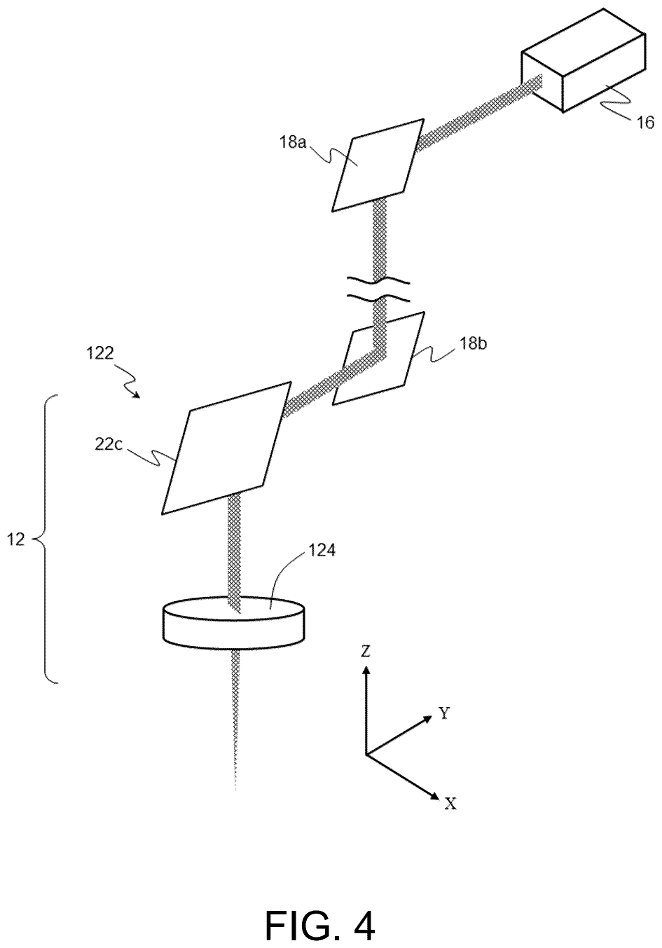

FIG. 4 shows another example of the scanner 122. As exemplified in FIG. 4, instead of a galvanometer, the scanner 122 may be configured with a digital micromirror device 22c. Alternatively, the scanner 122 may be configured with a combination of a polygon mirror and a motor. Any configuration that enables two-dimensional scanning of the laser beam may be adopted for the scanner 122.

The laser scanning head 12 includes a flat-field lens in addition to the scanner 122. In the examples shown in FIG. 3 and FIG. 4, the laser scanning head 12 includes an fθ lens 124. The fθ lens 124 may be a telecentric fθ lens or a non-telecentric fθ lens. Here, a telecentric fθ lens is used as the fθ lens 124, and in the scanning of the laser beam, the light passing through the fθ lens 124 proceeds parallel to the optical axis of the lens. In the examples shown in FIG. 3 and FIG. 4, the optical axis of the telecentric fθ lens is parallel to the Z-axis. In other words, here, the light that sequentially passes through the scanner 122 and the fθ lens 124 is incident perpendicular to the upper surface 14a of the stage 14. By adopting a telecentric fθ lens, it is possible to suppress the shape of the laser spot from approaching an ellipse.

In this manner, the laser scanning head 12 is configured to enable two-dimensional scanning of the laser beam within a plane parallel to the X-Y plane. By scanning the surface of the workpiece supported on the stage 14 with the laser beam from the laser scanning head 12 while switching the laser pulses on and off based on instructions from the control unit 20, it is possible to remove a part of the workpiece to obtain the intended shape (hereinafter referred to as the target shape).

However, the range in which the laser beam may be two-dimensionally scanned with the laser scanning head 12 and the stage 14 in a fixed arrangement relative to the frame 11 is limited by the configuration of the optical system of the laser scanning head 12. For example, in the case of using a telecentric fθ lens as the fθ lens 124, the range that may be two-dimensionally scanned is limited to the range where the beam passing through the fθ lens 124 may be scanned at a constant speed on a flat field, for instance, a circular area with a diameter of 120 mm. Thus, in the case where the size of the target shape is large, it is necessary to repeat the two-dimensional scanning of the laser beam with the relative arrangements of the laser scanning head 12 and the stage 14 fixed, and the movement of the laser scanning head 12 or the stage 14.

Here, the laser scanning head 12 is fixed within the X-Y plane relative to the frame 11, and the stage 14 is configured to be movable within the X-Y plane relative to the laser scanning head 12. However, this is not limited to this example, and the laser scanning head 12 and the stage 14 may be configured to be relatively movable to each other within a plane perpendicular to the Z-axis by any actuator. For example, the stage 14 may be fixed within the X-Y plane relative to the frame 11, and the laser scanning head 12 may be configured to be movable within the X-Y plane relative to the stage 14. Alternatively, both the laser scanning head 12 and the stage 14 may be configured to be independently movable within the X-Y plane relative to the frame 11.

The control unit 20 controls the operation of the laser scanning head 12 and the stage 14 of the machining unit 10. In a typical embodiment of the disclosure, the three-dimensional laser beam machining apparatus 1 executes automated machining with computer-aided manufacturing (CAM) applied. In the application of CAM, first, data representing a three-dimensional model of the final target shape (hereinafter referred to as a CAD model) is prepared using computer-aided design (CAD) or the like. The control unit 20 controls the operation of each portion of the machining unit 10 according to a machining program generated based on the CAD model. The details of the generation of the machining program is described later.

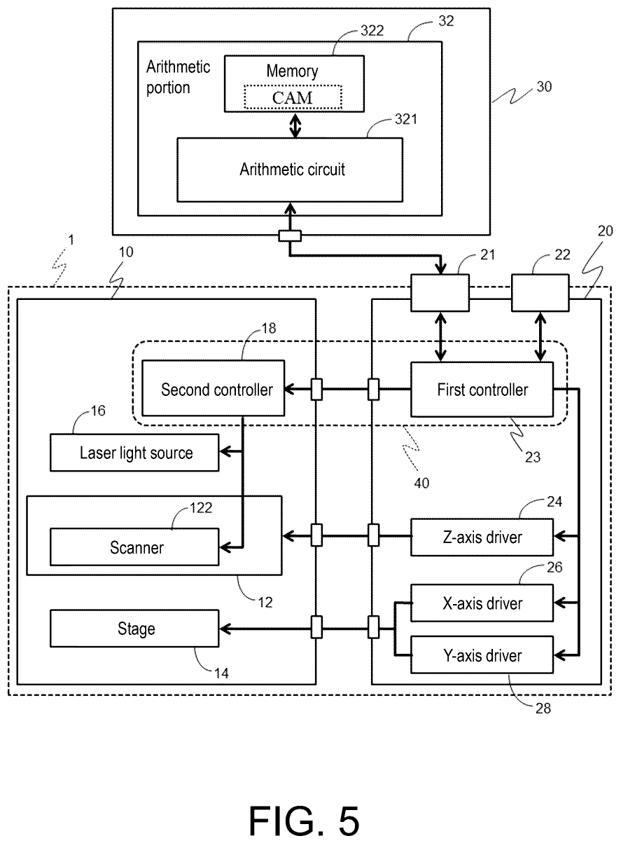

FIG. 5 shows an example of a control system in the three-dimensional laser beam machining apparatus 1. In a typical embodiment of the disclosure, the control unit 20 of the three-dimensional laser beam machining apparatus 1 includes one or more processors such as a CPU and one or more memories such as RAM. In the configuration exemplified in FIG. 5, the control unit 20 includes a first controller 23 configured, for example, by a CPU. In the example shown in FIG. 5, the control unit 20 further includes a first interface 21, a second interface 22, a Z-axis driver 24, an X-axis driver 26, and a Y-axis driver 28.

The first controller 23 receives the machining program through the first interface 21 and generates control signals to operate each portion of the machining unit 10 based on the machining program. Here, the first interface 21 is an external interface that realizes connection with external devices such as a computer with CAM software installed. The first interface 21 may take the form of a connector, jack, or socket for wired connection with external devices or the Internet. The first interface 21 may be a device configured to be wirelessly connectable to external devices or the Internet. Further, the first interface 21 may be a connector configured to be connectable to a recording medium on which the machining program is recorded.

In the example shown in FIG. 5, the control unit 20 includes a Z-axis driver 24 that controls the movement of the laser scanning head 12, and an X-axis driver 26 and a Y-axis driver 28 that control the movement of the stage 14. The Z-axis driver 24 controls the up and down movement of the laser scanning head 12 in the Z-direction based on control signals from the first controller 23. The X-axis driver 26 and the Y-axis driver 28 control the horizontal movement of the stage 14 based on control signals from the first controller 23.

The machining unit 10 includes a second controller 18 configured, for example, by a CPU. In the case where the scanner 122 includes, for example, a galvanometer scanner, the second controller 18 drives an actuator connected to the first galvanometer mirror 22a and an actuator connected to the second galvanometer mirror 22b. Here, the second controller 18 also has the function of a laser driver for controlling the operation of the laser beam source 16.

The aforementioned machining program includes instructions not only for the up and down movement of the laser scanning head 12 and the horizontal movement of the stage 14, but also for the two-dimensional scanning by the scanner 122. The second controller 18 downloads part or all the machining program from the first controller 23 and controls the operation of the first galvanometer mirror 22a, the second galvanometer mirror 22b, and the laser beam source 16 according to the machining program. That is, the first controller 23 and the second controller 18 constitute the controller 40 of the three-dimensional laser beam machining apparatus 1.

As mentioned above, in this embodiment, the controller 40 of the three-dimensional laser beam machining apparatus 1 is configured to include the first controller 23 and the second controller 18, but the two may be configured integrally.

The machining program for obtaining the final target shape may be prepared by an external device 30 separate from the three-dimensional laser beam machining apparatus 1, as described below. The external device 30 is, for example, a personal computer. In the configuration exemplified in FIG. 5, the external device 30 includes an arithmetic portion 32 having an arithmetic circuit 321 and a memory 322. A typical example of the memory 322 is a non-volatile storage device such as a magnetic disk drive or a solid-state drive. Here, CAM software is installed in the memory 322, and the arithmetic portion 32 may function as a CAM device.

The arithmetic circuit 321 of the arithmetic portion 32 is configured, for example, from a processor such as a CPU, and receives the import of a CAD model file to generate and output a machine-readable machining program describing instructions for driving each portion of the machining unit 10. As mentioned above, this machining program may include instructions related to the operation of the galvanometer mirrors 22a and 22b, and instructions related to the operation of the laser scanning head 12 and the stage 14. The external device 30 of this embodiment, or the arithmetic portion 32 thereof, may be said to be a machining program generation device.

The machining program generated in the external device 30 is passed to the control unit 20 via the first interface 21. The machining program may be transmitted by either wired or wireless method. Further, the machining program may be transmitted via a recording medium. When the first controller 23 of the control unit 20 receives the machining program, which is the output from the arithmetic portion 32, the first controller 23 executes machining to obtain the target shape on the machining unit 10 according to the machining program. More specifically, the first controller 23 controls the relative movement between the laser scanning head 12 and the stage 14 to position the same in a predetermined relative arrangement, and then sends instructions to the second controller 18 regarding two-dimensional scanning of the area to be irradiated. Based on the machining instructions, the second controller 18 operates the galvanometer mirrors 22a and 22b and the laser beam source 16 to remove unnecessary parts of the area subjected to two-dimensional scanning on the workpiece by laser irradiation. By repeating this laser beam irradiation from the laser scanning head 12 to the workpiece and the relative movement between the laser scanning head 12 and the stage 14 under the control of the first controller 23, unnecessary parts may be removed from the workpiece to obtain the shape of the finished product. The transmission of at least one of the drive signal and the control signal from the control unit 20 to the machining unit 10 may be executed by either wired or wireless method, similar to the exchange of the machining program.

As shown in FIG. 5, the control unit 20 may further include a second interface 22. The second interface 22 accepts commands from the operator of the three-dimensional laser beam machining apparatus 1. The second interface 22 is, for example, a touch panel, keyboard or button, or a combination of two or more of these. By including a touch panel as the second interface 22, the control unit 20 may be configured to display on the second interface 22 a simulation of the operation of the machining unit 10 when executing the machining program. Further, the control unit 20 may be configured to allow the operator to modify the machining program by inputting instructions via the touch panel.

Additionally, the machining unit 10 may include a camera or similar device to capture images of the workpiece on the stage 14. The first controller 23 of the control unit 20 may control the camera and the second interface 22 to display the images obtained by the camera. By providing such a camera in the three-dimensional laser beam machining apparatus 1, it is possible to observe the workpiece on the stage 14 during machining.

Next, an example of generating a machining program is described. As is well known, in general mechanical machining applying CAM, the generation of a machining program is roughly divided into two stages. The first stage is the determination of the tool path, and the second stage is the generation of a numerical control program corresponding to the determined tool path. The second stage is also called post-processing.

In this embodiment, as the target shape, a shape having a size exceeding the range that may be scanned by the laser scanning head 12 in a state where the arrangement of the laser scanning head 12 and the stage 14 is fixed is assumed. In other words, the cross-sectional area of the target shape at a certain height with reference to the upper surface 14a of the stage 14 is larger than the area of the area that may be scanned by the laser scanning head 12 at once. Thus, in a typical embodiment of the disclosure, first, a plurality of layers obtained by dividing the three-dimensional model of the target shape in the thickness direction (i.e., the height direction) are defined. Furthermore, each layer is divided into a plurality of irradiation areas, each having a predetermined size. Then, after setting a plurality of irradiation areas for each machining layer, machining is executed with the irradiation area as a unit.

As described in detail below, in this embodiment, the division lines defining the irradiation areas for each machining layer are slightly offset from each other among a plurality of machining layers, and the division into a plurality of irradiation areas is executed for each machining layer. For example, in the example described below, between two adjacent machining layers in the thickness direction of the three-dimensional model, a part of the irradiation area of one machining layer has an overlap in plan view with a corresponding one of the irradiation areas of the other machining layer. In other words, the boundaries (i.e., division lines) of a plurality of irradiation areas in a certain machining layer do not coincide with the boundaries of a plurality of irradiation areas in the machining layer immediately above or below it, but are slightly shifted. By intentionally avoiding the overlap of boundaries of a plurality of irradiation areas among a plurality of machining layers in this way, it is possible to prevent structures like streaks from remaining on the surface of the workpiece at positions corresponding to the boundaries of the irradiation areas. In other words, even if the target shape is larger than the range of a single irradiation area, machining may be achieved without degradation in quality.

The machining program according to a typical embodiment of the disclosure includes instructions regarding the sequence in which a plurality of irradiation areas are scanned with the laser beam. Hereinafter, these instructions may be simply referred to as instructions regarding the irradiation sequence. The determination of this irradiation sequence is equivalent to the determination of the tool path in CNC machine tools. By appropriately setting the irradiation sequence, it becomes possible to reduce machining time while avoiding degradation in machining quality.

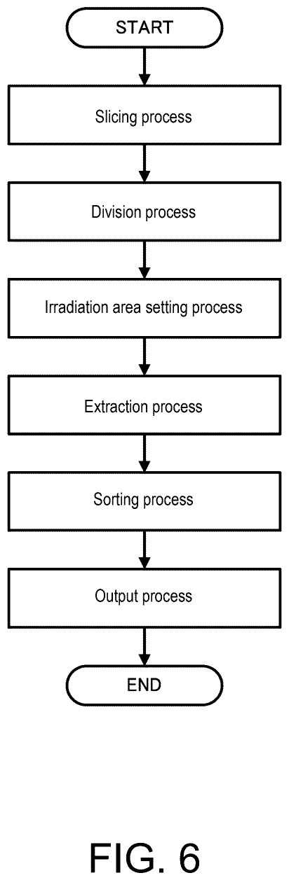

FIG. 6 is a flowchart illustrating an example of the method for generating machining program according to this embodiment. The method for generating machining program of this embodiment includes a slicing process, an irradiation area setting process, an extraction process, a sorting process, and an output process. Further, the method for generating machining program of this embodiment may further include a division process. The arithmetic circuit 321 of the arithmetic portion 32 of the external device 30 executes these processes. Further, a program that makes a computer execute these processes is installed in the memory 322 as CAM software. The program constituting the CAM software may be recorded on a recording medium. The recording medium may be a non-transitory recording medium.

In the slicing process, a plurality of layers are obtained by dividing the three-dimensional model of the target shape in the thickness direction. In the irradiation area setting process, a plurality of irradiation areas are generated by dividing each of the plurality of layers into predetermined sizes in the surface direction using division lines. At this time, the division lines are offset from each other for each adjacent layer. In the extraction process, a set of irradiation areas that include at least a part of the target shape is extracted from the plurality of irradiation areas. In the sorting process, the irradiation sequence of the irradiation areas included in the set is rearranged based on predetermined conditions. In the output process, a machining program is output as a machining instruction to the three-dimensional laser beam machining apparatus based on the rearranged irradiation sequence. It should be noted that the surface direction corresponds to the X-Y-direction during machining, and the thickness direction corresponds to the Z-direction during machining. The following sections describe these processes in more detail.

First, the slicing process is executed. When the arithmetic circuit 321 of the arithmetic portion 32 receives the file of the CAD model, it executes a check from a geometrical aspect to see whether the target shape includes any shapes that cannot be machined. If no errors related to geometric shapes are found, the arithmetic circuit 321 generates slice data of the target shape from the CAD model by dividing the CAD model in the thickness direction.

After the slicing process, the irradiation area setting process is executed. The arithmetic circuit 321 of the arithmetic portion 32 further generates a plurality of machining layers, each including a slice of the target shape, and divides each of the machining layers into a plurality of irradiation areas by mesh division.

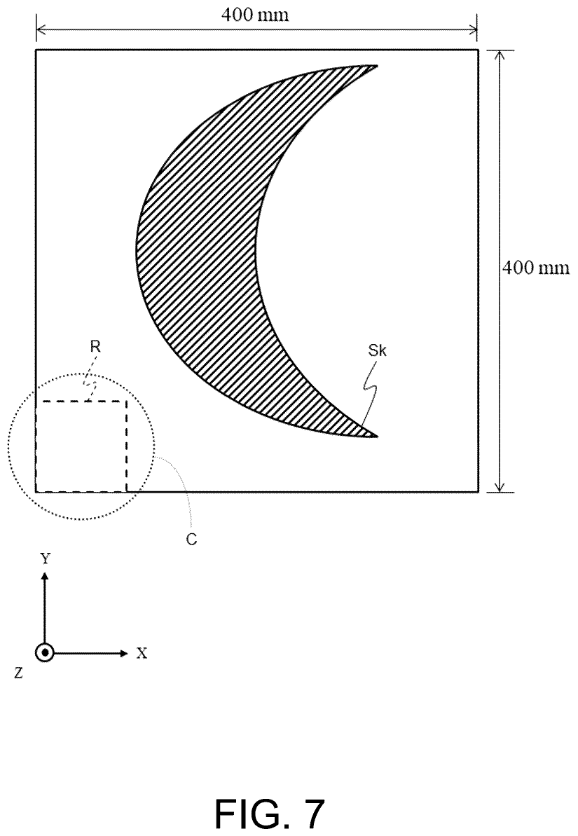

FIG. 7 schematically shows the relationship between a slice of the three-dimensional model of the target shape at a certain height and the area that may be scanned by the laser scanning head 12 at once. The three-dimensional model of the target shape may be represented as a collection of slice data obtained by cutting the target shape at a plurality of planes at different heights in the Z-direction. In the example shown in FIG. 7, the slice Sk of the target shape at a certain height, indicated by hatching, fits within a square area of 400 mm on each side. In this specification, a rectangular area that internally encompasses the cross-section obtained when cutting the target shape, such as the square area shown in FIG. 7, is conveniently referred to as a machining layer.

In this embodiment, the area that may be scanned at once by the laser scanning head 12 is smaller than the entire machining layer. The range that may be scanned by the laser scanning head 12 while maintaining the arrangement of the laser scanning head 12 and the stage 14 fixed relative to the frame 11 is limited to, for example, a circular area with a diameter of 120 mm. This range is schematically shown by the dotted circle C in FIG. 7. Thus, in the case where the size of the target shape is larger, it is necessary to move either or both of the laser scanning head 12 and the stage 14 and repeat the two-dimensional scanning of the laser beam.

As schematically shown by the dashed rectangular in FIG. 7, here, a rectangular area R smaller than the maximum range that may be scanned by the laser scanning head 12 with the arrangement of the laser scanning head 12 and the stage 14 fixed is assumed. The rectangular area R is, for example, a square area of 80 mm on each side. Then, the range of two-dimensional scanning of the laser beam with the arrangement of the laser scanning head 12 and the stage 14 fixed is restricted to this rectangular area R. In this specification, such a rectangular area is referred to as an irradiation area. By dividing each machining layer into a plurality of irradiation areas of a predetermined size by mesh division, the entire area of each machining layer may be covered with a plurality of irradiation areas. In other words, by repeating the two-dimensional scanning in units of irradiation areas within the machining layer, scanning of the entire machining layer is achieved.

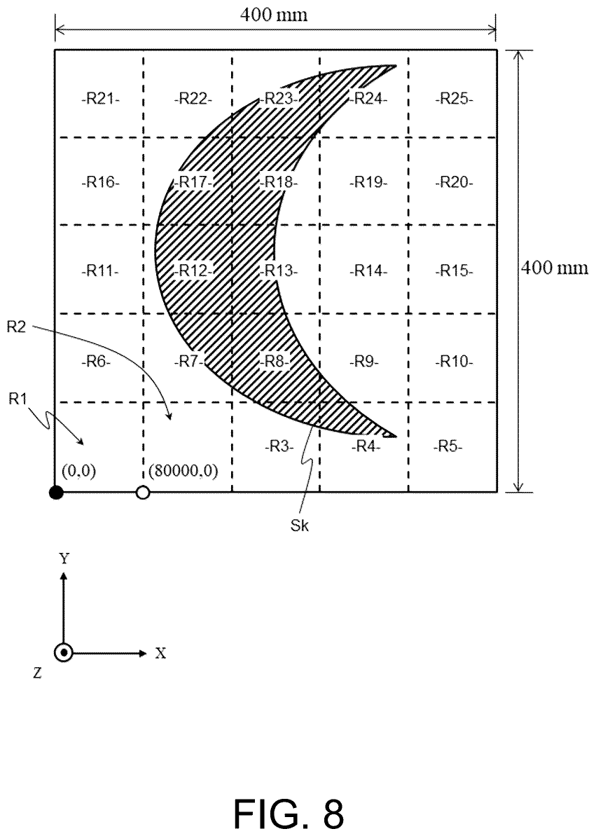

FIG. 8 illustrates an example of dividing a machining layer into a plurality of irradiation areas. In the case where a square area of 80 mm on each side is adopted as the rectangular area R, as schematically shown by the dashed lines in FIG. 8, a machining layer of 400 mm square size may be divided into a total of 25 irradiation areas R1 to R25, each having a size of 80 mm square. Then, these irradiation areas may be identified by specifying a representative point within the irradiation area. In the case where, for example, one of the vertices at the lower left of the rectangular area is used as the representative point, the positions of the irradiation areas R1 and R2 shown in FIG. 8 may be specified as (0,0) and (80000,0), respectively, using the coordinate values of the representative points. In other words, the coordinate values of the representative points may be used as labels for each irradiation area.

In this way, each irradiation area may be labeled, for example, by the coordinate values of the representative point. Thus, all the plurality of irradiation areas obtained for each machining layer may be expressed by a set of a plurality of numerical values, such as coordinates. The set of a plurality of numerical values may be, for example, in the form of (serial number of the irradiation area in the machining layer of interest, serial number of the machining layer, X-coordinate of the representative point, Y-coordinate of the representative point). Here, the serial number of the machining layer is a label indicating which layer of the slice data it is. In the case where the slice Sk shown in FIG. 8 belongs to, for example, the k-th layer (k is a natural number) of the machining layer, the irradiation areas R1 and R2 may be expressed as (1,k,0,0) and (2,k,80000,0), respectively.

In this embodiment, the plurality of machining layers obtained by division in the thickness direction include a first layer and a second layer that are adjacent to each other. Here, the second layer is a layer positioned one above or one below the first layer in the thickness direction.

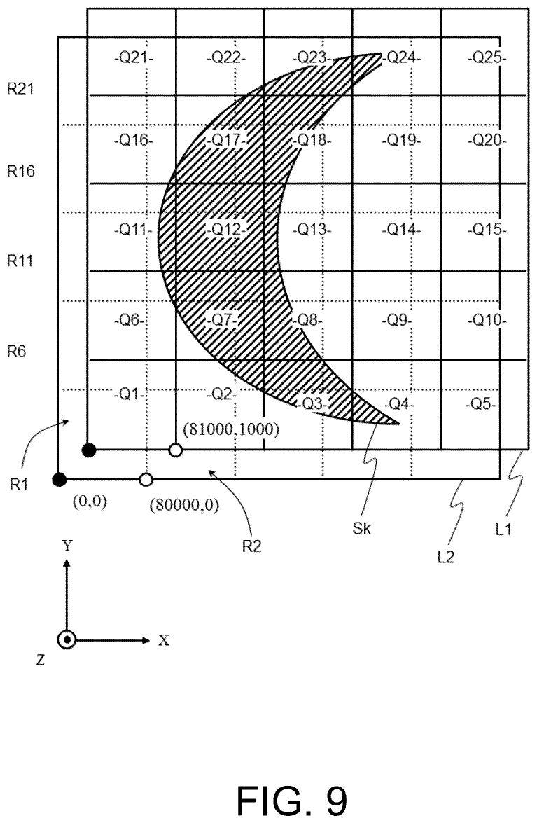

FIG. 9 shows the division in the first layer superimposed on the division in the second layer. In the example shown in FIG. 9, the second layer L2 is, for example, the k-th layer in the thickness direction of the target shape. Here, the thickness direction coincides with the Z-direction. The second layer L2 includes 25 irradiation areas R1 to R25, each having a predetermined size. On the other hand, the first layer L1, which is, for example, the (k+1)-th layer, also includes irradiation areas Q1 to Q25 of the same size as each of the irradiation areas R1 to R25. However, as schematically shown in FIG. 9, focusing on, for example, the irradiation area Q2 among the irradiation areas Q1 to Q25 of the first layer L1, this irradiation area Q2 has an overlap in plan view with a part of the irradiation area R2 corresponding to the irradiation area Q2 in the second layer L2. In other words, a part of the rectangular outline defining the irradiation area Q2 overlaps with the irradiation area R2 in plan view.

In the case where the label expressing the irradiation area R2 of the second layer L2 is, for example, (2,k,80000,0), then the label expressing the irradiation area Q2 of the first layer L1 may be, for example, (2,k+1,81000,1000). In other words, in this example, the irradiation area Q2 of the first layer L1 is offset by 1 mm in the X-direction and 1 mm in the Y-direction with respect to the irradiation area R2 of the second layer L2. This example is not limiting, and the offset amount between layers may be set as appropriate, and there is no need for the offset amount to be the same between the X-direction and the Y-direction.

As an offset between adjacent layers in the thickness direction, for example, a magnitude may be adopted such that the total amount of offset in 1000 machining layers becomes ((length L of one side of the irradiation area)/(total number N of machining layers)). The diameter of a typical telecentric fθ lens is, for example, approximately 1000 times the spot diameter of a femtosecond laser, which is 10 to 30 μm. Further, when the irradiation area is rectangular, the length of one side of the rectangle is about 1000 times the spot diameter of the laser. Thus, it is reasonable to calculate the offset amount based on approximately 1000 machining layers as a unit. If Z is the value obtained by dividing the total number N of machining layers by 1000 and rounding to an integer, the offset amount T between machining layers may be adopted as the magnitude calculated from T=L/(N/(Z+1)). Adopting an offset of this magnitude is beneficial as it may uniformly distribute the boundaries of the irradiation areas.

As understood from FIG. 9, in this example, the entire first layer L1 is offset within the X-Y plane with respect to the entire second layer L2. In FIG. 9, for the convenience of explanation, the offset between the first layer L1 and the second layer L2 is exaggerated. It should be noted that it is not essential for the outlines of the machining layers to match between a plurality of machining layers. Also, it is not essential for the number of irradiation areas included in the machining layers to be the same between a plurality of machining layers.

After the irradiation area setting process, the extraction process is executed. As understood from FIG. 8, when focusing on one machining layer, the plurality of irradiation areas include those that have at least a part of the slice of the target shape (here, slice Sk) and those that do not have the slice of the target shape. In machining the workpiece, it is said that there is no significance in executing scanning by the laser beam for irradiation areas that do not have the slice of the target shape. Thus, it is beneficial to include information about whether the irradiation area has the slice of the target shape in the set of numbers specifying the irradiation area. For example, a flag may be set for irradiation areas that have the slice of the target shape. In this case, for example, the irradiation areas R1, R2, and R3 shown in FIG. 8 may be expressed as (1,k,0,0,0), (2,k,80000,0,0), and (3,k,160000,0,1), respectively. The last one of the set of five numbers specifying the irradiation area corresponds to the aforementioned flag. As in the label assigned to the irradiation area R3, the flag being set to “1” indicates that the irradiation area includes a part of the slice of the target shape.

In this embodiment, after executing labeling using sets of numbers for a plurality of irradiation areas of each machining layer, the arithmetic circuit 321 extracts a set of irradiation areas that include at least a part of the target shape from among the plurality of irradiation areas. In the example of the k-th layer shown in FIG. 8, the arithmetic portion 32 extracts R3 to R4, R7 to R9, R12 to R13, R17 to R18, and R22 to R24 from the irradiation areas R1 to R25. The extraction of the set of irradiation areas may be easily executed by selecting those with the aforementioned flag set (i.e., those with a flag value of “1”) among the labels (e.g., sets of numbers) representing each irradiation area.

Similarly, the arithmetic circuit 321 extracts Q2 to Q4, Q6 to Q8, Q11 to Q13, Q16 to Q18, and Q22 to Q24 from the irradiation areas Q1 to Q25 (refer to FIG. 9) of the first layer L1, which is the machining layer of the k+1-th layer. As mentioned above, here, the first layer L1 includes the irradiation area Q2 (first irradiation area) that has an overlap with a part of the irradiation area R2 (second irradiation area) of the second layer L2 in plan view.

It should be noted that, for simplicity, it is assumed here that the shape of the slice of the target shape included in the first layer L1 of the k+1-th layer is the same as the shape of the slice of the target shape included in the second layer L2 of the k-th layer. In general, the shape of the slice of the target shape may differ between different machining layers.

After the extraction process, the sorting process is executed. Upon completion of the extraction of irradiation areas with flags set, the arithmetic circuit 321 rearranges the labels (e.g., sets of numbers) specifying each extracted irradiation area based on predetermined conditions. The irradiation areas with flags set are the irradiation areas among all irradiation areas that are subject to laser beam scanning. That is, the list of irradiation areas rearranged based on predetermined conditions constitutes instructions regarding the irradiation sequence for the machining unit 10.

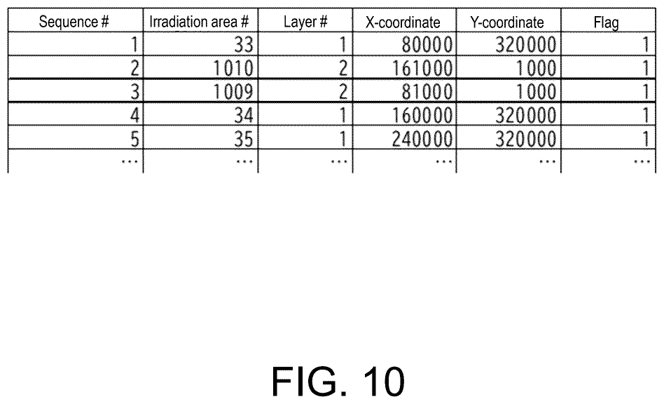

FIG. 10 shows an example of a list after rearranging the labels (e.g., sets of numbers) representing each irradiation area under predetermined conditions. In FIG. 10, an example of a list is shown where each row describes data in the form of (sequence number, serial number of irradiation area, serial number of machining layer, X-coordinate of representative point, Y-coordinate of representative point, flag). It is noted that although omitted in FIG. 10, such a list as a machining program also includes instructions for each irradiation area regarding the operation of the scanner 122 such as a galvanometer scanner. After obtaining a list as shown in FIG. 10, the simulation results of the machining may be displayed on the second interface 22 of the control unit 20, which is, for example, a touch panel.

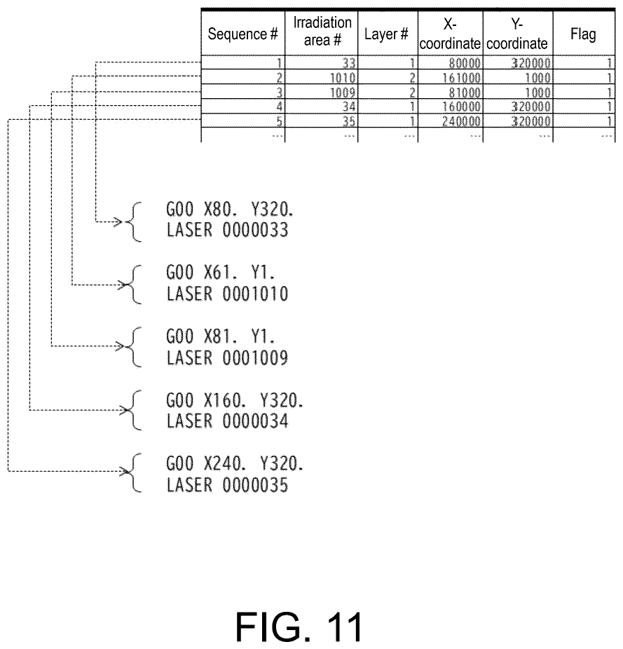

After the sorting process, the output process is executed. When a list as shown in FIG. 10 is obtained, the arithmetic circuit 321 converts the content of the list into a machine-readable numerical control program and outputs the numerical control program as a machining instruction. This conversion corresponds to the aforementioned post-process. FIG. 11 shows an example of a numerical control program corresponding to the list shown in FIG. 10. The numerical control program as an output from the arithmetic portion 32 is equivalent to G-code in CNC machine tools. This post-process may be executed in the arithmetic portion 32 of the external device 30, or it may be executed in a processor on the control unit 20 side, for example, in the first controller 23. The numerical control program may further include data related to laser irradiation conditions such as spot size, fluence, and irradiation frequency.

The numerical control program generated by, for example, the arithmetic circuit 321 of the arithmetic portion 32 is sent to the first controller 23 of the control unit 20 via the first interface 21. The first controller 23 and the second controller 18 that have received the numerical control program generate control signals for operating each portion of the machining unit 10 based on the numerical control program. In this embodiment, the laser scanning head 12 scans the surface of the workpiece with the laser beam in units of irradiation areas to remove a part of the workpiece, based on the drive signal generated by the second controller 18. That is, the laser scanning head 12 executes removal machining of the workpiece in each of the plurality of irradiation areas. By sequentially scanning the surface of the workpiece with the laser beam according to the numerical control program as shown in FIG. 11, or the content of the list as shown in FIG. 10, a finished product with the intended shape is obtained.

The method for three-dimensional laser beam machining of this embodiment includes a process of obtaining a target shape by removing a part of the workpiece in a predetermined irradiation sequence by scanning the surface of the workpiece with the laser beam in units of irradiation areas, based on the machining program generated by the machining program generation method described above. It is noted that in the example explained here, the arithmetic portion 32 of the external device 30 generates a machining program that selectively executes laser scanning by the laser scanning head 12 for irradiation areas that include at least a part of the target shape among the entire plurality of irradiation areas defined for each machining layer, and gives instructions to the second controller 18 of the machining unit 10. In this way, by selectively executing laser scanning for irradiation areas that include at least a part of the target shape, the effect of reducing the lead time related to machining may be obtained while avoiding the deterioration of machining quality in the boundary portion of adjacent irradiation areas. Especially in the case of adopting a galvanometer scanner as the scanner 122, under the control where the laser beam scanning operation is stopped during the movement of the stage 14, the effect of reducing the downtime of the galvanometer may be expected. The reduction of lead time required for the entire machining process also leads to energy savings required for machining.

The sorting process is now described in further detail. As mentioned above, after rearranging the labels of the irradiation areas with flags set based on predetermined conditions, the scanning of the laser beam is executed according to the rearranged order. That is, the irradiation sequence related to the irradiation areas included in the set of irradiation areas extracted according to whether they include a part of the target shape or not is rearranged based on predetermined conditions. The predetermined conditions here are, for example, conditions that minimize the total machining time. The predetermined conditions may be appropriately defined according to manufacturing needs.

In this embodiment, the laser scanning head 12 executes removal machining in units of irradiation areas according to the specified irradiation sequence in accordance with the machining program. Although the laser scanning head 12 may execute machining sequentially for each machining layer, the irradiation areas subject to laser beam scanning may be discontinuous within one machining layer, as understood from FIG. 10. Furthermore, the sequence of laser beam scanning may be specified across a plurality of machining layers.

In this embodiment, the arithmetic portion 32, in generating the machining program, rearranges the irradiation areas subject to laser beam scanning in a sequence that minimizes the set temporal cost. The determination of the irradiation sequence is equivalent to solving a so-called combinatorial optimization problem under conditions that minimize the cost.

In the case of executing laser beam scanning in units of irradiation areas, after completing the scanning of one irradiation area, the machining unit 10 moves either or both of the laser scanning head 12 and the stage 14 so that the laser spot moves to the next irradiation area. Thus, the distance of the trajectory of the relative movement of the laser scanning head 12 with respect to the stage 14 may be the cost in the total machining time. For example, the arithmetic portion 32 rearranges the irradiation areas included in the extracted set of irradiation areas in a sequence that minimizes the in-plane movement distance of the stage 14 or the laser scanning head 12. Alternatively, the machining time itself required to obtain the target shape from the workpiece by laser beam irradiation from the laser scanning head 12 may be set as the cost.

The solution to the combinatorial optimization problem for determining the irradiation sequence may be obtained using known methods. The irradiation sequence may be determined by applying techniques such as simulated annealing or quantum annealing. The controller 40 of the control unit 20 may cause the laser scanning head 12 to execute removal machining in units of irradiation areas in an irradiation sequence that minimizes the appropriately defined cost, in accordance with the machining program generated by the arithmetic portion 32.

It is noted that an irradiation sequence in which scanning of a certain irradiation area of a certain machining layer is followed by scanning an irradiation area located almost directly above or almost directly below the irradiation area while maintaining the positions of either or both of the laser scanning head 12 and the stage 14 fixed in the Z-direction is also acceptable.

The laser beam used in the three-dimensional laser beam machining apparatus 1 of this embodiment may specifically be a Gaussian beam. The Gaussian beam has a beam waist where the beam diameter has a minimum value. In removal machining, utilizing this beam waist is advantageous in terms of machining efficiency. In addition, near the beam waist, there is no significant change in the beam diameter. Thus, for irradiation areas positioned within a predetermined range centered on the beam waist in the Z-direction, scanning may be executed while maintaining the positions of either or both of the laser scanning head 12 and the stage 14 fixed in the Z-direction.

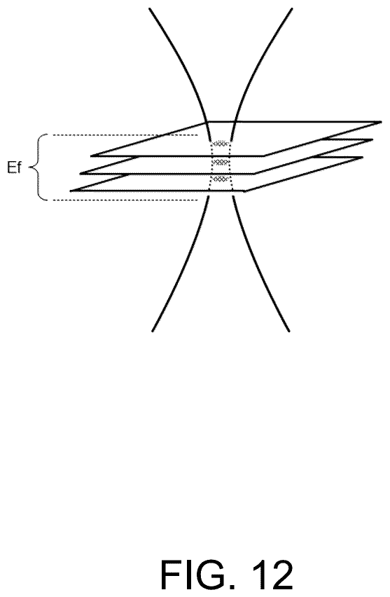

FIG. 12 schematically shows an example where irradiation areas of a plurality of machining layers are positioned within a predetermined range centered on the beam waist. The range where there is no significant change in beam diameter centered on the beam waist is defined as an effective portion Ef. For the irradiation areas included in this effective portion Ef, scanning of these irradiation areas may be executed sequentially, for example, without lowering the laser scanning head 12 in the Z-direction. In this case, before rearranging the labels of the irradiation areas, for example, after extracting the irradiation areas with flags set, a process of dividing the entire plurality of machining layers into two or more layer groups may be executed. The number of machining layers included in each layer group is the number of machining layers included in the effective portion Ef. The number of machining layers included in the effective portion Ef may be obtained by dividing the length of the effective portion Ef in the Z-direction by the interval between adjacent machining layers, that is, the machining depth per layer. In the case where the length of the effective portion Ef in the Z-direction is, for example, 50 μm, and the machining depth per scan is, for example, 1 μm, machining may be realized for irradiation areas of up to 50 layers without moving the laser scanning head 12 and so on. It is noted that the length of the effective portion Ef may be set to approximately the Rayleigh length, for example, in the case of a Gaussian beam.

In this way, for removal machining of some consecutive machining layers in the Z-direction among a plurality of machining layers, control may also be adopted that does not change the distance from the laser scanning head 12 to the stage 14 and the position of the beam waist of the laser beam. In setting the combinatorial optimization problem for determining the irradiation sequence, a condition may be imposed that rearrangement of irradiation areas transitioning between machining layers is limited to irradiation areas belonging to the same effective portion Ef. For example, before rearranging the labels of the irradiation areas, a process may be executed to group the machining layers in units of the Z-direction length of the effective portion Ef and divide the plurality of machining layers into layer groups. Then, a process may be executed to extract a set of irradiation areas including at least a part of the target shape from machining layers included in the same layer group, and rearrange the irradiation sequence for the irradiation areas included in the extracted set of irradiation areas.

In other words, the method for generating machining program may further include a division process that divides a plurality of layers into layer groups, each having a plurality of layers included in the effective portion Ef. Further, the extraction process may include a process of extracting a set of irradiation areas included in the same layer group. In this embodiment, the division process is executed immediately after the slicing process, but is not limited thereto. The machining program output in the output process includes commands to change the distance from the laser scanning head 12 to the stage 14. Commands to change the distance from the laser scanning head 12 to the stage 14 are inserted for each laser machining instruction for a layer group having a plurality of layers.

By considering such constraints, the number of up and down movements of the laser scanning head 12 may be reduced. The maximum number of machining layers that may be included in the effective portion Ef may be appropriately determined according to the machining depth in a single scan.

As described above, in this embodiment, overlapping of boundaries of a plurality of irradiation areas between a plurality of machining layers is intentionally avoided. By offsetting one of the adjacent machining layers in the thickness direction relative to the other in a direction perpendicular to the thickness direction, machining may be achieved without quality degradation even if the target shape is larger than the range of a single irradiation area. It should be noted that it is not essential to generate an offset for all machining layers, and the entire set of machining layers may include a set of two or more machining layers where the boundaries of the irradiation areas overlap in the thickness direction.

In the above-mentioned example, the external device 30 serving as the machining program generation device determines the irradiation sequence of the irradiation areas based on predetermined conditions. However, this is not limited to this example, and for example, the rearranging of labels specifying each irradiation area may be executed by the first controller 23 of the control unit 20. Alternatively, two or more processes among the extraction of a set of irradiation areas including at least a part of the target shape, the rearrangement of labels specifying each of these irradiation areas, and the conversion to a numerical control program may be executed by the first controller 23.

The generation of the machining program may be executed by an information processing device separate from the three-dimensional laser beam machining apparatus 1. As the external device 30, a personal computer installed with CAD tools in addition to CAM software may be used to generate the machining program. In such a configuration, the transfer of the CAD model from the CAD tool to the CAM software is completed within that computer.

The software or application for generating the machining program related to the disclosure may be downloaded through an electrical telecommunication line, or read from a machine-readable recording medium such as an optical disc, and installed in a storage device provided in a personal computer or the like. In this case, by installing the aforementioned software or application, a general-purpose personal computer, for example, may be transformed into a machining program generation device.

The machining program output from the external device 30 may be provided to the three-dimensional laser beam machining apparatus 1 via a recording medium such as a USB flash memory or an optical disc. The transmission and reception of the machining program may be executed through a network such as LAN or the Internet. The machining method related to the disclosure may be realized in the form of providing a machining program containing instructions to be executed by a processor or the like. The personal computer serving as the machining program generation device does not necessarily need to be constantly connected to the three-dimensional laser beam machining apparatus 1 by wire or wireless means.

Although various embodiments of the disclosure have been described, these embodiments are mere examples and are not intended to limit the scope of the invention. Novel embodiments may be implemented in various other forms, and various omissions, replacements, and changes may be made without departing from the gist of the invention. These embodiments and their modifications are included within the scope and gist of the invention, as well as within the scope of the invention described in the claims and its equivalents.

What is claimed is:

1. A three-dimensional laser beam machining apparatus, comprising:
a laser scanning head, configured to remove a part of a workpiece by scanning a surface of the workpiece with a laser beam using an irradiation area of a predetermined size as a unit;
a stage, supporting the workpiece; and
a controller, configured to control, based on a machining program, an irradiation of the laser beam from the laser scanning head to the workpiece, and a relative movement between the laser scanning head and the stage,
wherein the laser scanning head and the stage are configured to be relative movable with respect to each other,
the machining program comprises instructions regarding an irradiation sequence of the laser beam for a plurality of irradiation areas, each having the predetermined size, and
the plurality of irradiation areas are areas defined by dividing each of a plurality of layers, obtained by dividing a three-dimensional model of a target shape in a thickness direction, into a predetermined size in a surface direction using division lines, and the division lines are offset from each other for each adjacent layer.

2. The three-dimensional laser beam machining apparatus according to claim 1, wherein the controller is configured to control the laser scanning head and the stage so as not to change a distance from the laser scanning head to the stage and a position of a beam waist of the laser beam during removal machining for part of layers of the plurality of layers that are continuous in the thickness direction.

3. The three-dimensional laser beam machining apparatus according to claim 1, wherein the controller is configured to cause the laser scanning head to execute removal machining in units of the irradiation area in an irradiation sequence that minimizes either a distance of a trajectory of relative movement of the laser scanning head with respect to the stage, or a machining time required to obtain the target shape from the workpiece by irradiation of the laser beam from the laser scanning head.

4. The three-dimensional laser beam machining apparatus according to claim 1, wherein the controller is configured to cause the laser scanning head to selectively execute laser scanning on an irradiation area among the plurality of irradiation areas that comprises at least a part of the target shape.

5. The three-dimensional laser beam machining apparatus according to claim 1, wherein the controller is configured to determine the irradiation sequence by rearranging labels of the irradiation areas based on predetermined conditions, and to cause the laser scanning head to execute removal machining in units of the irradiation area in the irradiation sequence.

6. The three-dimensional laser beam machining apparatus according to claim 1, further comprising a laser beam source, optically coupled to the laser scanning head,
wherein the laser scanning head comprises a scanner and an fθ lens.

7. The three-dimensional laser beam machining apparatus according to claim 1, wherein the laser beam is a femtosecond laser beam.

8. A method for three-dimensional laser beam machining of a three-dimensional laser beam machining apparatus based on a machining program generated by a method for generating a machining program, wherein
the three-dimensional laser beam machining apparatus comprises a laser scanning head, configured to remove a part of a workpiece by scanning a surface of the workpiece with a laser beam using an irradiation area of a predetermined size as a unit; and a stage, supporting the workpiece, the laser scanning head and the stage are configured to be relatively movable with respect to each other,
the method for generating the machining program comprises:
a slicing process of obtaining a plurality of layers by dividing a three-dimensional model of a target shape in a thickness direction;
an irradiation area setting process of dividing each of the plurality of layers into a predetermined size in a surface direction with division lines to generate a plurality of irradiation areas, wherein the division lines are offset from each other for each adjacent layer;
an extraction process of extracting a set of irradiation areas that include at least a part of the target shape from the plurality of irradiation areas;
a sorting process of rearranging an irradiation sequence of the irradiation areas included in the set based on predetermined conditions; and
an output process of outputting a machining program as a machining instruction for the three-dimensional laser beam machining apparatus based on the irradiation sequence that is rearranged, and
the method for three-dimensional laser beam machining comprises obtaining the target shape by scanning a surface of a workpiece with a laser beam in units of the irradiation area and removing a part of the workpiece in the irradiation sequence according to the machining program.

9. The method for three-dimensional laser beam machining according to claim 8, wherein the sorting process comprises a process of rearranging the irradiation sequence of the irradiation areas included in the set such that either a distance of a trajectory of relative movement of the laser scanning head with respect to the stage, or a machining time required to obtain the target shape from the workpiece by irradiation of the laser beam from the laser scanning head, becomes minimum.

10. The method for three-dimensional laser beam machining according to claim 8, wherein the method for generating the machining program further comprising a division process of dividing the plurality of layers into layer groups, each having a plurality of layers included in an effective portion where a beam diameter is equal within a range centered on a beam waist in the thickness direction,
wherein the extraction process comprises a process of extracting a set of irradiation areas included in the same layer group.

11. A machining program generation device, comprising an arithmetic circuit that executes the slicing process, the irradiation area setting process, the extraction process, the sorting process, and the output process according to claim 8.

12. A non-transitory recording medium, recording a program that causes a computer to execute the slicing process, the irradiation area setting process, the extraction process, the sorting process, and the output process according to claim 8.
